(19) United States
(12) Patent Application Publication
(10) Pub. No.: US 2005/0162340 A1
(43) Pub. Date: Jul. 28, 2005

(54) Display apparatus for vehicles

(76) Inventors: Keiichi Nagano, Nagaoka, Niigata (JP); Katsuei Takatoh, Nagato, Niigata (JP); Shigehiko Hara, Nagaoka, Niigata (JP)

Correspondence Address: McDermott Will & Emery, 600 13th Street N W, Washington, DC, 20005-3096, US

(21) Appl. No.: 10/511,185

(22) PCT Filed: Feb. 19, 2003
(86) PCT No.: PCT/JP03/01828

(30) Foreign Application Priority Data
Apr. 22, 2002 (JP) 2002-118972
May 20, 2002 (JP) 2002-144356

(51) Int. Cl. G09G 5/00

(52) U.S. Cl. 345/7

(57) ABSTRACT

A display device 11 emits display light L. A reflecting member 13 reflects the display light L. Driving means 18 angularly moves the reflecting member 13 in a predetermined angle range. When an ignition switch is turned off, control means angularly moves the reflecting member 13 to a middle position of the angle range. A memory part memorizes angular position data of the reflecting member 13. Memory operating means makes the angular position data to be memorized in the memory part 36. When the ignition switch is turned on, the reflecting member 13 is angularly moved according to the angular position data memorized in the memory part.

### TECHNICAL FIELD

The present invention relates to display apparatus for vehicles, particularly relates to display apparatus for vehicles in which an angular position of a reflecting member for reflecting display light emitted from a display device is adjustable.

### BACKGROUND ART

There has been head up display apparatus that displays a virtual image V by projecting display light L from a display unit 2 to a windshield 1 of a vehicle (refer to FIG. 7). The display unit 2 has a display device 3 such as fluorescent display tube, reflecting mirror 4 for reflecting display light L emitted from the display device 3, and stepping motor 5 for rotating the reflecting mirror 4, which are contained in a housing 6 (refer to FIG. 8). A gear 7 is mounted on a rotation axis of the stepping motor 5, and engaged with a gear part 9 fixed to a holding member 8 for holding the reflecting mirror 4.

A driver can set an angular position of the reflecting mirror 4 in an angle range (for example, 6 deg.) between an upper limit position and a lower limit position by operating a not-shown push button switch, thereby adjust a direction of the display light L projected to the windshield 1. For example, when the angular position of the reflecting mirror 4 is set near the lower limit position, the mirror can be set suit for a driver D1 having a high visual point, and when the angular position of the reflecting mirror 4 is set near the upper limit position, the mirror can be set suit for a driver D2 having a low visual point. To avoid complicity of the figure, in FIG. 9, the angle range between the upper limit position and the lower limit position is shown in a magnified manner.

However, there has been a problem in the case that the driver D1 finishes driving of a vehicle by turning off an ignition switch, and at a later date, another driver D2 adjusts the angular position of the reflecting mirror 4. That is, the angular position of the reflecting mirror 4 must be angularly moved from neighborhood of the lower limit position to neighborhood of the upper limit position, resulting in a large moving angle, therefore long time (for example, 2 sec.) is required for setting the angular position of the reflective mirror 4 by manual operation.

The invention, which was made in the light of the problem, provides display apparatus for vehicle in which the angular position of the reflecting mirror can be set in comparatively short time.

### DISCLOSURE OF THE INVENTION

The display apparatus for vehicles has a display device and a reflecting member, and displays a virtual image by reflecting display light emitted from the display device using the reflecting member. The reflecting member can be angularly moved by a driving mechanism to adjust a display position of the virtual image. The display apparatus for vehicles has a first operating switch for angularly moving the reflecting member upward and a second operating switch for angularly moving the reflecting member downward.

When the ignition switch is turned off, the reflecting member is angularly moved to a middle position of a predetermined angle range. The middle position is an origin position. When a driver adjusts the angular position of the reflecting member and then pushes a memory switch, the angular position of the reflecting member is memorized in a memory part. When the ignition switch is turned on, the reflecting member is angularly moved to the angular position memorized in the memory part.

### BRIEF DESCRIPTION OF THE DRAWINGS

FIG. 1 is a section view of a display unit showing an embodiment of the invention;

FIG. 2 is an explanatory drawing of a movable range of a reflecting mirror;

FIG. 3 is a block diagram of head up display apparatus;

FIG. 4 and FIG. 5 are flow charts of angular movement of the reflecting mirror; and,

FIG. 6 is an explanatory drawing of the angular movement of the reflecting mirror.

FIG. 7 to FIG. 9 are views showing examples in the related arts; wherein FIG. 7 is a view of a schematic configuration of head up display apparatus; FIG. 8 is a section view of a display unit; and FIG. 9 is an explanatory drawing of the angular movement of the reflecting mirror.

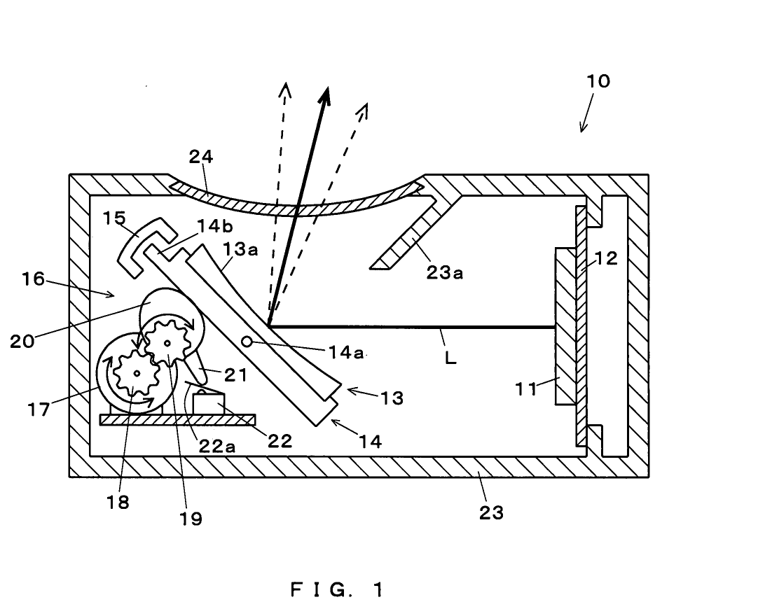

### BEST MODE FOR CARRYING OUT THE INVENTION

Hereinafter, an embodiment in which the invention is used for the head up display apparatus is described according to appended drawings.

10 is a display unit, and the display unit 10 is arranged in a dashboard of a vehicle. Display light L projected by the display unit 10 is reflected by a windshield toward a driver. The driver of the vehicle can see a virtual image superposed with scenery.

11 is a liquid crystal display device (display device), and the liquid crystal display device comprises a TFT liquid crystal display element and a backlight. 12 is a circuit board, and the liquid crystal display device 11 is mounted on the circuit board 12. 13 is a reflecting mirror (reflecting member), and the reflecting mirror 13 reflects the display light L emitted from the liquid crystal display device 11 to the windshield. The reflecting mirror 13 includes a reflecting face 13a formed by evaporating a metal such as aluminum on resin such as polycarbonate. The reflecting face 13a of the reflecting mirror 13 is a concave face, and can project the display light L from the liquid crystal display device 11 to the windshield in a magnified manner.

14 is a holding member, and the reflecting mirror 13 is fixed to the holding member 14 by a pressure sensitive adhesive double coated tape. The holding member 14 has an axis 14a, and the axis 14a is pivotally supported by a bearing provided in a housing described later. The reflecting mirror 13 and the holding member 14 are supported in a swingable manner, and angularly moved around the axis part 14a. The holding member 14 has a protrusion 14b. 15 is a stopper, and the stopper 15 is contacted with the protrusion 14b, thereby a movable range of the reflecting mirror 13 is limited.

16 is a driving mechanism (driving means), and the driving mechanism 16 has a stepping motor 17, gear 18, gear 19 and cam 20. Using the driving mechanism 16, the angular position of the reflecting mirror 13 is adjusted in the angle range between the upper limit position and the lower limit position. The gear 18 is fixed to a rotation axis of the stepping motor 17, and the gear 19 is engaged with the gear 18. The cam 20 is fixed to the gear 19, and rotates around an axis of the gear 19. The holding member 14 is pressed to the cam 20 by a not-shown coil spring, and the reflecting mirror 13 is angularly moved with the holding member 14 by rotation of the cam 20.

21 is a striker, and the striker 21 is integrally formed with the cam 20. 22 is a microswitch, and the microswitch 22 is turned on by the striker 21 when the reflecting member 13 is near the origin position of the movable range. That is, the microswitch 22 detects whether the reflecting member 13 is near the origin position or not.

23 is a housing, and the housing 23 contains the liquid crystal display device 11, circuit board 12, reflecting mirror 13, driving mechanism 16 and the like. 23a is a shading wall, and the shading wall 23a is integrally formed with the housing 23, and prevents a phenomenon (washout) that outside light such as sunlight is entered into the liquid crystal display device 11, causing reduction of visuality of the virtual image. A translucent cover 24 through which the display light L passes is arranged in the housing 23. The translucent cover 24, comprising translucent resin such as acrylic resin, has an arcuate shape.

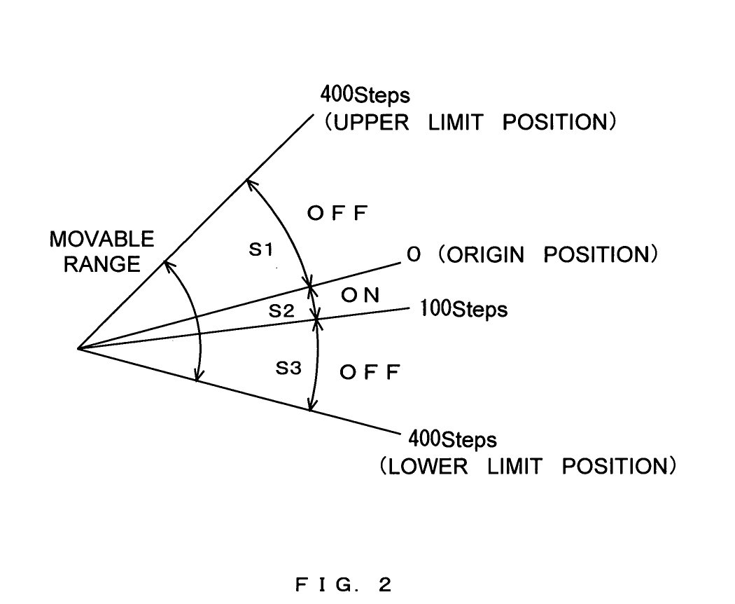

Next, the movable range and the like of the reflecting mirror 13 are described according to FIG. 2. The movable range of the reflecting mirror 13, which is appropriately established according to an area, called eye range, in which eyes of the driver are set, is about 6 deg. in this embodiment, or 800 steps in the number of steps of the stepping motor 17. The origin position is a center of the rotation range, and a range S1 from the origin position to the upper limit position is 400 steps, and ranges S2, S3 from the origin position to the lower limit position are 400 steps. The range S2 in which the microswitch 22 is turned on is 100 steps or less from the origin position to a side of the lower limit position.

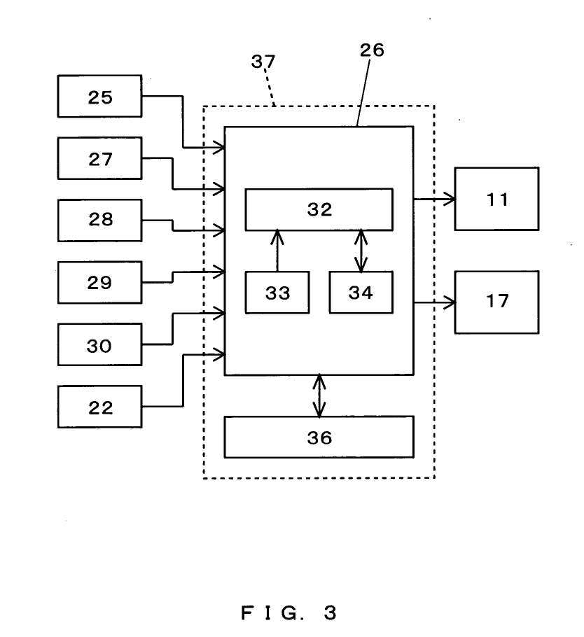

FIG. 3 is a block diagram showing an electrical configuration of the head up display apparatus. 25 is a velocity sensor, and the velocity sensor 25 detects velocity of the vehicle and outputs a velocity signal to a microcomputer 26. 27, 28 are push button switches. When the push button switches 27, 28 are turned on, a switch operating signal is outputted to the microcomputer 26, and the microcomputer 26 outputs a driving signal to the stepping motor 17 through a not-shown driver circuit, thereby rotates a rotation axis of the stepping motor 17. The stepping motor 17 rotates about 0.23 deg. per step, and makes one turn at 1560 steps. When the push button 27 is turned on, the reflecting mirror 13 is angularly moved downward, and when the push button 28 is turned on, the reflecting mirror 13 is angularly moved upward.

29 is a memory switch (memory operating means), and when the memory switch 29 is turned on, a switch operating signal is outputted to the microcomputer 26. When the memory switch 29 is remained on for at least 5 seconds, the microcomputer 26 makes angular position data of the reflecting mirror 13 at the point be memorized in EEPROM described later. That is, when the memory switch 29 is continuously pushed for at least 0.5 sec., the angular position of the reflecting mirror 13 at the point (hereinafter, mentioned as memory position) is memorized.

When the memory switch 29 is turned on and then turned off in less than 0.5 sec., the microcomputer 26 outputs a driving signal to the stepping motor 18 according to the memorized angular position data. That is, when the memory switch 29 is remained on for less than 0.5 sec., the reflecting mirror 13 is angularly moved to the memorized angular position.

30 is an ignitions witch, and the ignition switch 30 outputs an ignition state signal indicating which position of OFF, ACC, and ON the ignition is located on to the microcomputer 26. The microswitch 22 detects whether the reflecting mirror 13 is near the origin position (or a position about 3 deg. upper from the lower limit position) or not.

In this specification, “when the ignition switch is turned on” includes not only when the ignition switch 30 is turned from ACC to ON, but also turned from OFF to ACC, and “when the ignition switch is turned off” includes not only when the ignition switch 30 is turned from ON to ACC, but also turned from ACC to OFF.

The microcomputer 26 has CPU 32, ROM 33 and RAM 34, and performs predetermined arithmetic processing according to a velocity signal to indicate the velocity on the liquid crystal display device 11, or activates the stepping motor 18 to adjust the angle of the reflecting mirror 13. 36 is the EEPROM (memory part), and the EEPROM 36 stores the angular position data memorized by operating the memory switch 29. The angular position data are the number of steps from the central position to the memory position. A control part 37 (control means) comprises the microcomputer 26 and the EEPROM 36.

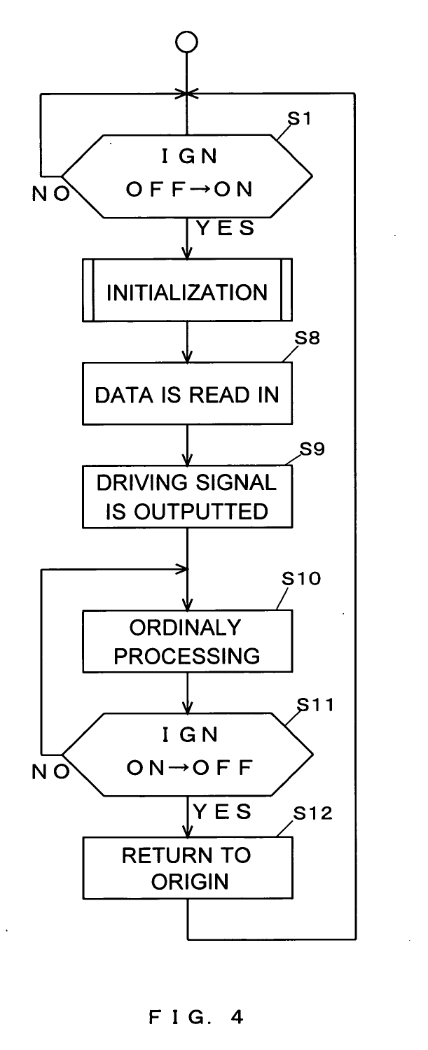

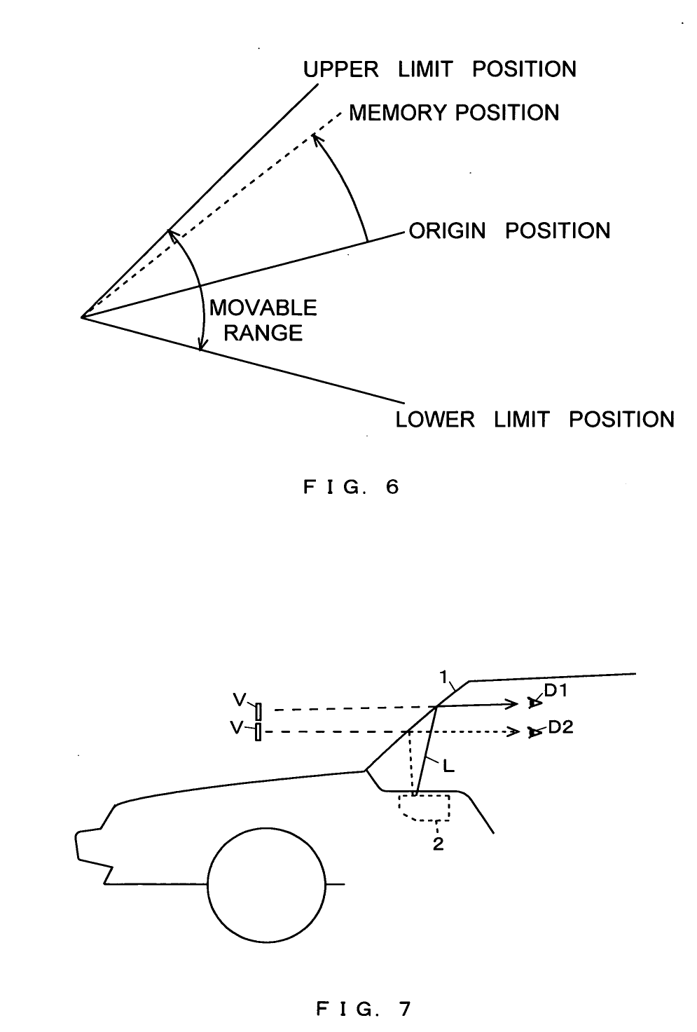

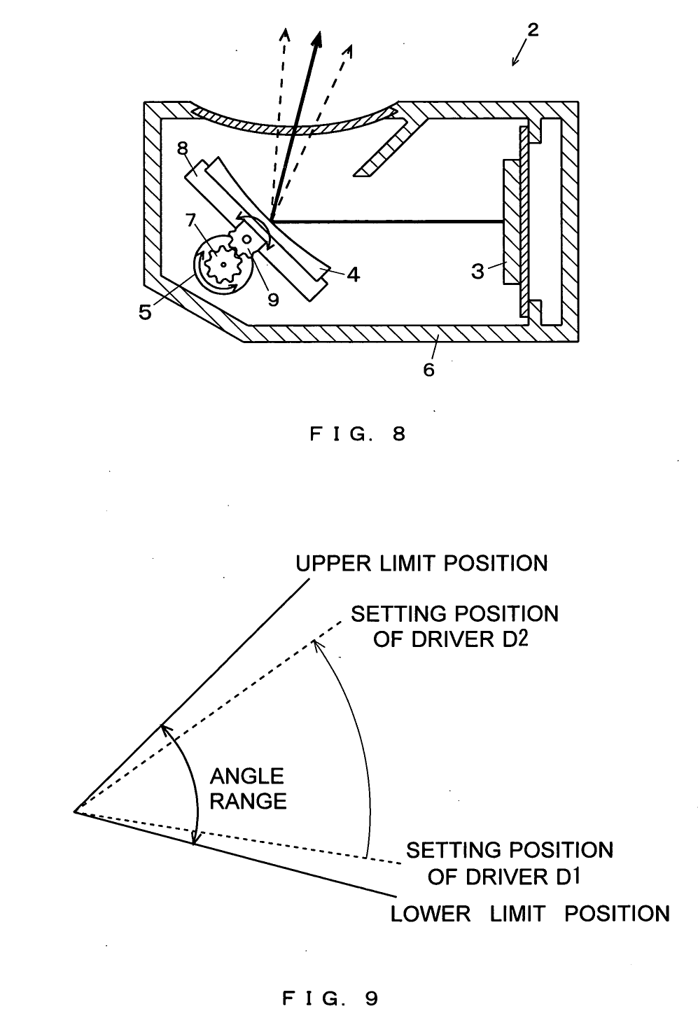

Next, the angular movement to the memory position is described in detail according to a flowchart shown in FIG. 4. The microcomputer 26 monitors whether the ignition switch 30 is turned on or not (step S1). When the ignition switch 30 is turned on, initialization is executed. The initialization is described later. Next, the memorized angular position data are read out from the EEPROM 36 (step S8). Next, in step S9, a driving signal is outputted to the stepping motor 18 through the driving circuit according to the read-out angular position data, thereby the reflecting mirror 13 is angularly moved to the memory position (refer to FIG. 6). After processing of step S3 is completed, the microcomputer 26 performs ordinary processing such as velocity indication (step S10). When the ignition switch 30 is turned off, the microcomputer outputs a driving signal to the stepping motor 17 to return the reflecting mirror 13 to a central position as the origin position (steps S11, S12).

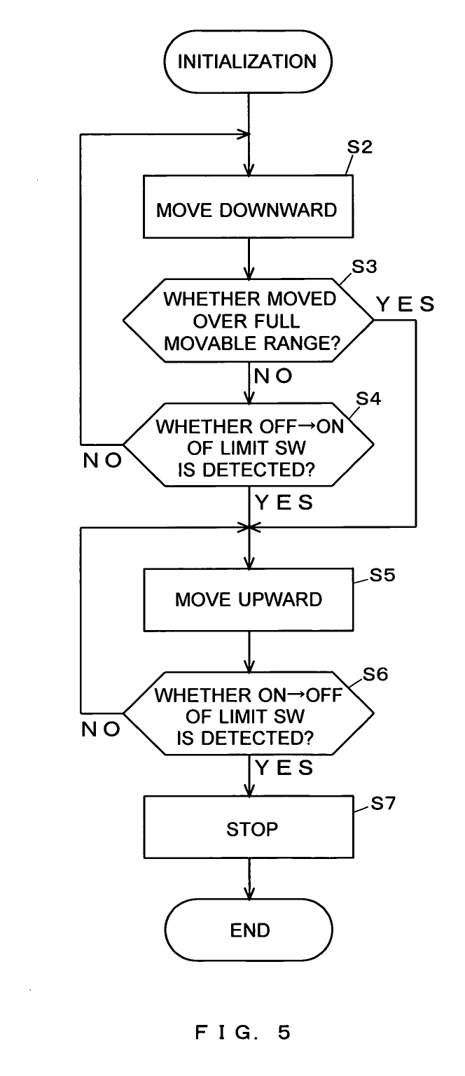

Next, the initialization is described in detail according to a flowchart shown in FIG. 5. When the ignition switch 30 is turned on, the microcomputer 26 outputs a driving signal to the stepping motor 17 to angularly move the reflecting mirror 13 downward (step S2). In steps S2, S3, when the microswitch 22 is turned from off to on, and when the microswitch 22 is not turned from off to on even if the rotation axis of the stepping motor 17 rotates 800 steps, the initialization is advanced to step S5. Next, in steps S5, S6, when the microswitch 22 is turned from on to off by angularly moving the reflecting mirror 13 upward, the stepping motor 17 is stopped.

In the stepping motor 17, there is an advantage that a rotation angle of the rotation axis can be specified by giving the number of steps in correspondence with a desired rotation angle, but on the other hand, a phenomenon of step-out occurs. The step-out is a phenomenon that since the rotation axis of the stepping motor 17 has an infinite number of magnetically stable positions, the axis jumps over an original angular position and shifts to another stable position (for example, refer to JP-A-8-182392). Therefore, in the embodiment, when the ignition switch 30 is turned on, the reflecting mirror 13 is returned to the origin position, and even if the step-out phenomenon occurs due to some reason, the reflecting mirror 13 can be angularly moved to the memory position.

In the embodiment, when the ignition switch 30 is turned off, the reflecting mirror 13 is returned to the central position, thereby when the vehicle is intended to be restarted, since the reflecting mirror 13 is in the central position, a period while the reflecting mirror 13 is angularly moved to the memory position can be comparatively reduced.

When the ignition switch 30 is turned off, the angular position to which the reflecting mirror 13 is returned can not be the central position, and for example, if it is a position upper from 2 deg. to 4 deg. from the lower limit position, the advantage that the period while the reflecting mirror 13 is angularly moved to the memory position is comparatively reduced is obtained.

In addition, a function of memorizing the memory position may not be provided, and when the ignition switch 30 is turned off, the reflecting mirror 13 is returned to the middle position, thereby the angular position of the reflecting mirror 13 can be set in shorter time than in the related arts.

In the embodiment, the angular position of the reflecting mirror 13 is memorized in the EEPROM 36, thereby complexity of adjusting the angular position of the reflecting mirror 13 can be reduced. When the ignition switch 30 is turned on, the reflecting mirror 13 is returned to the origin position, and the reflecting mirror 13 is aligned with the predetermined angular position using the number of steps from the origin position, and even if the angle sensor for detecting the angular position of the reflecting mirror 13 is not provided, the reflecting mirror 13 can be aligned with the memory position.

In the embodiment, when the ignition switch was turned on, the reflecting mirror 13 was angularly moved to the memory position memorized using the memory switch 29. However, it is sufficient that an angular position at the time the ignition switch 30 was turned off is memorized, and when the ignition switch 30 is turned on, the reflecting mirror 13 is angularly moved to the angular position at the time the ignition switch 30 was turned off.

In addition, while the display device in the embodiment was the liquid crystal display device 11, it can be, for example, a fluorescent display tube or an organic EL display panel. Also, while the stepping motor 17 was employed in the driving mechanism 16, for example, a servomotor can be employed. Also, while the memory part was the EEPROM 36, it can be, for example, a flash memory. Also, while the detecting means was the microswitch 22, it can be, for example, a photosensor.

Furthermore, in the embodiment, while only one of the angular position data of the reflecting mirror 13 is memorized, a plural number of angular position data can be memorized in order to memorize at least two memory positions. In addition, while the embodiment was an embodiment of the head up display, it will be obvious that the embodiment can be applied to, for example, a virtual-image-display combination meter.

It is desired that the liquid crystal display device 11 is remained off during the initialization (step S2 to step S6) and the return to origin (step S11, step S12).

### Industrial Applicability

The invention is usable for the display apparatus for vehicles, and particularly suitable for the head up display apparatus for vehicles.

1. Display apparatus for vehicles characterized by having a display device that emits display light, a reflecting member for reflecting the display light, driving means for angularly moving the reflecting member, and control means for angularly moving the reflecting member to a middle position of a predetermined angle range when an ignition switch is turned off.

2. The display apparatus for vehicles according to claim 1 characterized by having a memory part for memorizing an angular position of the reflecting member and memory operating means for making the angular position be memorized in the memory part.

3. The display apparatus for vehicles according to claim 2 characterized in that when the ignition switch is turned on, the reflecting member is angularly moved to the angular position memorized in the memory part.

4. The display apparatus for vehicles according to claim 1 characterized by having a first operation switch for angularly moving the reflecting member upward and a second operation switch for angularly moving the reflecting member downward.

5. The display apparatus for vehicles according to claim 1 characterized by having detecting means for detecting the middle position of the reflecting member.

6. Display apparatus for vehicles having a display device that emits display light, a reflecting member for reflecting the display light, and driving means for angularly moving the reflecting member in a predetermined angle range characterized in that a middle position of the angle range is an origin position.

7. The display apparatus for vehicles according to claim 6 characterized by having control means for angularly moving the reflecting member to the origin position when an ignition switch is turned on.

8. The display apparatus for vehicles according to claim 6 characterized in that a memory part for memorizing an angular position of the reflecting member and memory operating means for making the angular position be memorized in the memory part are provided.

9. The display apparatus for vehicles according to claim 8 characterized in that when the ignition switch is turned on, the reflecting member is angularly moved to the origin position, and then the reflecting member is angularly moved to the angular position memorized in the memory part.

10. The display apparatus for vehicles according to claim 6 characterized in that the driving means has a stepping motor.

11. The display apparatus for vehicles according to claim 10 characterized in that when the ignition switch is turned on, even if the stepping motor outputs the number of steps in correspondence with the movable range and thus the reflecting member is angularly moved to one of an upside and a downside, if the detecting means does not detect that the reflecting member positions near the origin position, the control means angularly moves the reflecting member to the other of the upside and the downside, thereby the reflecting member is returned to the origin position.
